(19) United States
(12) Patent Application Publication
(10) Pub. No.: US 2010/0239816 A1
(43) Pub. Date: Sep. 23, 2010

(54) COMPOSITE BUILDING PANEL AND METHOD OF MAKING SAME

(76) Inventor: Jerald E. Kinkade, Springfield, MO (US)

Correspondence Address: POLSINELLI SHUGHART PC, 700 W. 47TH STREET, SUITE 1000, KANSAS CITY, MO, 64112-1802, US

(21) Appl. No.: 12/563,901

(22) Filed: Sep. 21, 2009

Related U.S. Application Data
(60) Provisional application No. 61/202,366, filed on Feb. 23, 2009.

(51) Int. Cl. E04C 2/24; B32B 5/16; B29C 41/20; E04C 2/02; B29C 70/00

(52) U.S. Cl. 428/142; 428/143; 428/149; 264/271.1; 264/257; 264/129; 264/279

(57) ABSTRACT

The composite building panel is a decorative panel for use as a roofing shingle, an interior wall panel or the like. The composite building panel includes a layer of polymer with a layer of particulate matter partially embedded therein. The particulate matter may be in the form of granular ceramic or the like. The process for preparing the composite building panel includes the steps of first depositing a layer of the particulate matter on a molding surface, and then depositing a layer of polymer on to the layer of particulate matter, such that a sheet is formed.

### CROSS-REFERENCE TO RELATED APPLICATION

This application claims the benefit of and priority to U.S. Provisional Patent Applications Ser. No. 61/202,366, filed Feb. 23, 2009, entitled COMPOSITE BUILDING PANEL, which application is hereby incorporated by reference to the extent permitted by law.

### BACKGROUND OF THE INVENTION

1. Field of the Invention

The present invention relates to a composite building panel that includes particulate matter, such as ceramic granules, mineral granules, or glass granules or aggregate partially embedded within a polymer layer. The invention also relates to a method of manufacturing the composite building panel whereby layers of particulate matter and polymer are individually deposited onto a molding surface, with the layers combining to embed the particulate matter, and form the desired panel.

2. Description of the Related Art

Traditional building panel products include roofing and siding materials such as asphalt-based panels, wood shakes, slates, metal panels, aluminum siding, vinyl siding, and the like. The different types of products offer unique benefits. Wood shakes and slate panels offer aesthetic advantages given their physical characteristics, and proven consumer appeal; however, wood shake and slate tend to be expensive. Less expensive panel products are available, such as asphalt shingles, which have been developed to simulate the aesthetic appeal of these products, but with little success. Generally, the incorporation of natural materials has become expensive, and results in a substantial increase in the weight of the product. As a result, many manufacturers have begun using synthetic materials that can be molded and shaped to provide the desired aesthetic appeal.

In addition, multilayer structural materials employing an outer layer of glass or particulate matter are popular structural materials and have been incorporated for use in tile, brick, paneling, shingles, and the like. The inner face of the glass is typically painted, or the glass is tinted or colored in order to give the glass-based panel a desired appearance. Such glass-based composite panels are used in a variety of architectural applications, both internally and externally with regard to the structure. Glass composite panels may be used on walls to form shower or bathtub enclosures, on walls as decorative panels, or on external walls or other surfaces, such as spandrels, exterior tiles, or shingles.

Composite tiles, shingles, and the like are well known, and are often formed of plastics, ceramics, and metal. Typical prior art glass composite panel structures, however, have excessive weight associated therewith, relatively high manufacturing costs, and often require specialized mounting brackets to secure the panel to a building surface. It would be desirable to provide a composite panel incorporating a particulate matter surface that is relatively light in weight, yet is structurally strong and resistant to shock. Further, it would be desirable to provide such a panel that is also relatively inexpensive and easy to manufacture. Thus, a composite building panel solving the aforementioned problems is desired.

Furthermore, the manufacturing of composite building panels incorporating particulate matter and glass aggregate encompasses a wide variety of potential methods. Manufacturing methods include extrusion, injection, induction curing, powder coating, preheated manufacture, and the like. Many of these methods, however, have proven to be expensive and inefficient due to the fact that granular material causes excessive wear on manufacturing equipment such as compression molds. Methods of manufacturing composite panels that replicate shake and slate shingles are also known, but typically incorporate the mixing of all components prior to extrusion, molding, compression, etc. The mixing of components results in a product where the particulate matter is dispersed throughout the entire volume of the polymer, and do not offer the aesthetic quality of having an exposed surface comprising primarily particulate matter. In addition, many of the prior art methods require individualized attention and labor to produce the desired product. Many of the prior art methods are incapable of being automated due to the fact that extensive care and attention are required in the fabrication process.

Moreover, the prior art discloses various methods for manufacturing asphalt shingles which incorporate exposed frit (granular) material. The range of frit that may be used with these methods is limited, thereby limiting the range of aesthetic possibilities. Additionally such methods incorporate the use of asphalt or tar-based substrates, which are not environmentally friendly. Thus, the methods described by the prior art are not capable of producing the composite building panel described herein and the methods tend to be inefficient and expensive. It would be desirable to have a method of manufacturing composite panels that incorporates an automated production process, can be performed efficiently and inexpensively, and allows the manufacturer to create a composite building material wherein the particulate matter is partially embedded in the polymer, allowing granular material to remain exposed on one surface of the composite building panel.

### SUMMARY OF THE INVENTION

The present invention relates to a composite building panel that is a decorative panel for use as a roofing shingle, an interior wall panel, an interior ceiling panel, an exterior wall panel, a foundation panel, or the like. The composite building panel includes a polymer layer, with a layer of particulate matter partially embedded therein. As used herein, the term partially embedded should be construed as describing an orientation of the particulate matter whereby the posterior surface of the particulate matter is bound to the polymer by the adhesive qualities of the polymer when melted. The adhesion of the posterior surface of the particulate matter requires that the anterior surface of the particulate matter remain exposed. The particulate matter can be of a variety of sizes, shapes, and colors, providing a variety of decorative uses. In general, any particulate material having a granular diameter ranging from approximately 0.01 mm to approximately 50 mm can be used. Furthermore, any polymer with general resistance to temperatures ranging from approximately −200° F. to approximately 300° F., and having a high tensile strength can be used. The composite building panel disclosed is unique because the particulate matter is partially exposed on one surface of the panel. As such, the resultant composite building panel has a decorative side comprised primarily of particulate matter and an opposite side comprised of polymer. The polymer side can have additional components added such as an adhesive or attachment material. A typical resultant panel has a side with a frit and glass aggregate layer bound by a thermoplastic polymer. Resultant panels will generally be square-shaped and can have an adhesive or attachment material on the side opposite the frit and glass aggregate.

The process for preparing the composite building panel includes the steps of first depositing a layer of the particulate matter on to a molding surface. A layer of polymer comprising liquefied, melted, or solid pellets or granules is then deposited onto the layer of particulate matter. The layer of polymer is then adhered to the particulate matter such that the posterior surface of the particulate matter is partially embedded within the polymer. The physical state of the polymer when it is deposited on to the particulate matter, will determine the appropriate means for adhering the layers. If the polymer comprises a liquefied or melted polymer, the layers need only be allowed to cool and solidify. If the polymer is deposited in solid pellets or granules, all layers are exposed to a heating element at a temperature ranging from about 150° F. to about 600° F., which acts to melt the polymer and cause the polymer to adhere to the posterior surface of the particulate matter. The melting of the polymer results in partially embedded particulate matter, leaving a portion of the particulate matter exposed. Regardless of whether a heating element is required, the resulting composite sheet is allowed to cool and exposed to a particle removal device that contacts the face of the sheet with the exposed particulate matter, removing any loose particles. Subsequently the composite sheet is fed through a panel-cutting device, where individual panels are cut therefrom, dependent upon the desired size and shape. Finally, the individual composite building panels are moved to a collection area for package and transport.

These and other features of the present invention will become readily apparent upon further review of the following specification and drawings.

### BRIEF DESCRIPTION OF THE DRAWINGS

FIG. 1 is a plan view of a composite building panel according to the present invention.

FIGS. 2A, 2B and 2C are side views in section illustrating successive formation steps of the process of forming the composite building panel of FIG. 1.

FIG. 2D is a side view in section illustrating an optional step in a process of forming an alternative embodiment of a composite building panel according to the present invention.

FIG. 3 is a diagrammatic side view showing an apparatus for forming the composite building panel according to the present invention.

Similar reference characters denote corresponding features consistently throughout the attached drawings.

### DETAILED DESCRIPTION OF THE PREFERRED EMBODIMENTS

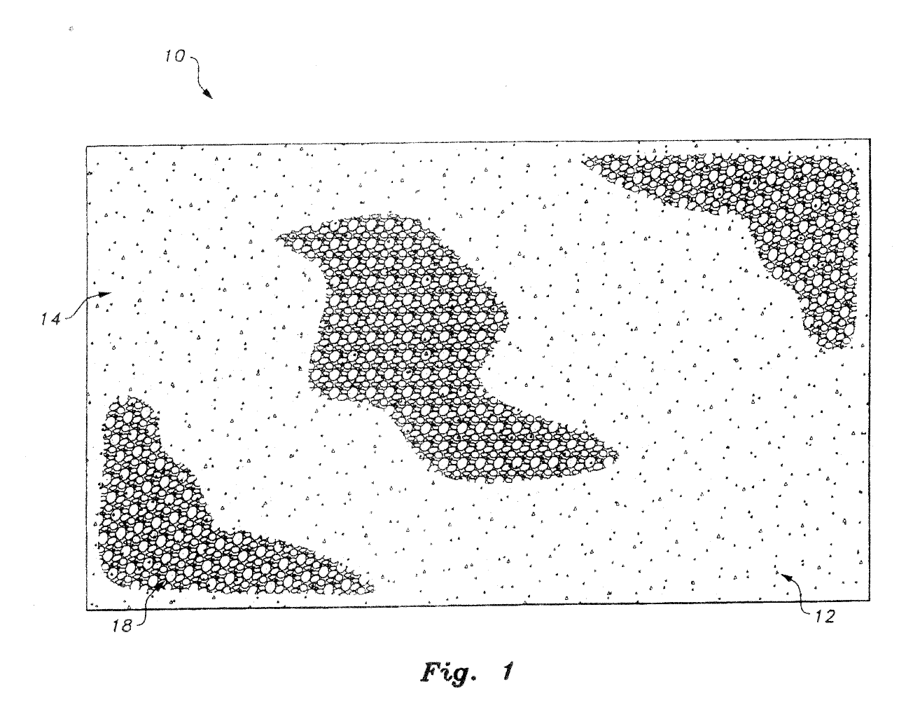

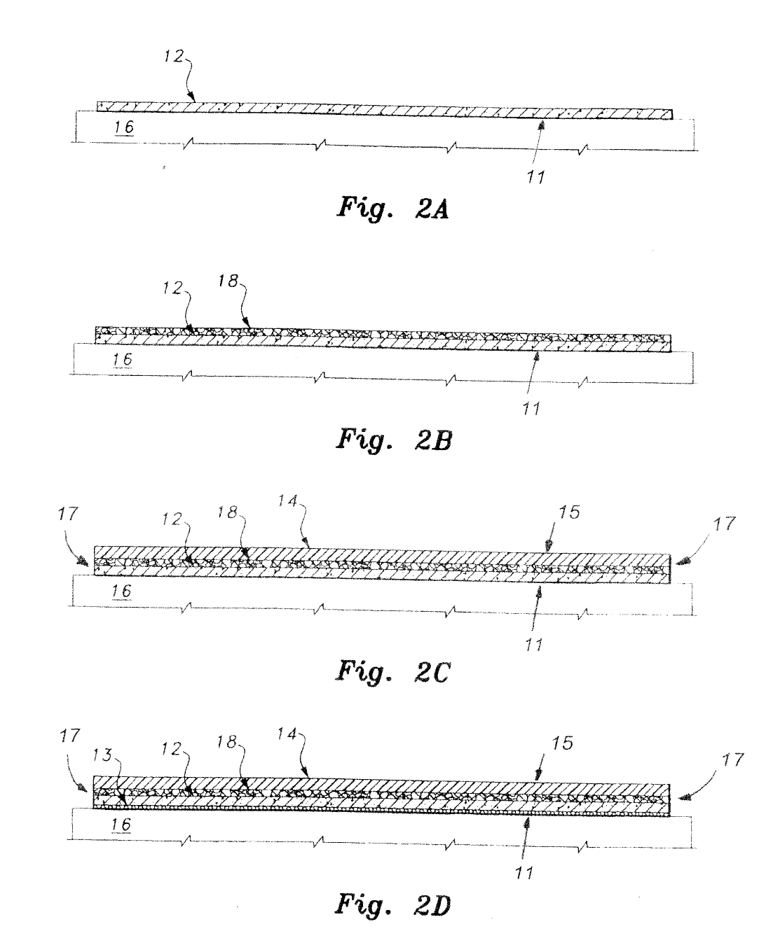

Generally, the current invention is a composite building panel 10, as illustrated in FIGS. 1 and 2, with two opposing surfaces 11 and 15. One surface 15 is comprised of polymer. The decorative surface 11 is primarily composed of particulate matter, which is partially embedded within the polymer, and partially exposed. The partially embedded and partially exposed particulate matter creates a composite building panel that may be incorporated into walls, ceilings, foundations, roofs, or any other structure desired. The current invention provides qualities such as the texture and feel of natural particulate matter in a variety of sizes, shapes, and colors, which may be individualized to consumer tastes. Unlike the compositions of the prior art, the composite building panel of the current invention incorporates these features, while avoiding the use of asphalt or tar-based substrates that are hazardous to the environment. Further, the use of a flexible polymer surface allows for ease of use and manipulation. In addition, the components of the current invention may be recycled, providing an environmentally conscious alternative for composite building panels.

In general, the composite building panel is a decorative panel for use as a roofing shingle, an interior wall panel or the like. The composite building panel 10 has one surface 11 that is decorated and an opposite surface 15 for attachment, which may comprise a smooth or scored polymeric surface, or have materials attached thereto. The composite building panel 10 also comprises at least one edge 17. The number of edges 17 present on the composite building panel will vary depending upon the shape chosen for the panel. The decorated side has particulate matter embedded in a polymer, in which the decorative material remains exposed. Opposite the exposed side of particulate, the particulate or decorative material is adhered to a polymer. Thus, the particulate or decorative material is partially embedded to ensure secure attachment to the opposite side, and partially exposed to impart the described appearance. The polymer forms a face opposite the particulate matter known as the polymeric face or side. The surface of the opposing side may remain exposed, or may have an additional material affixed thereto.

The shape of the composite building panel 10 may vary depending on the desired appearance of the panel, but generally includes circular panels, square panels, rectangular panels, triangular panels, and the like. The composite building panel can also be cut to take the form of specialized shapes and designs. Further, the composite building panel can be cut to any desired width, length, or size. Generally, the thickness of the edge 17 is less than the width and length of the decorated side and the opposing side. The thickness of the composite building panel is determined by the cumulative thickness of the decorated side and the opposing side. The cumulative thickness of the composite building panel ranges from approximately 1/100 of an inch to approximately 2 inches, however, varying thicknesses can be achieved based on the desired end use of the panel. In a preferred embodiment, the thickness of the composite building panel ranges from approximately 1/32 of an inch to approximately 1 inch. In a more preferred embodiment, the thickness of the composite building panel ranges from approximately ⅛ of an inch to approximately ½ inch.

The composite building panel of the current invention is generally produced by partially embedding the posterior portion of the decorated side within the opposing side. The composite building panel is typically formed from a polymer. The polymer is generally defined as a large molecule (macromolecule) composed of repeating structural units typically connected by covalent chemical bonds. The polymer of the current invention should be defined to include polymers, plastics, metals, and polymer/metal hybrids. Generally, the polymer is classified as one of two types: a thermoplastic polymer or a thermosetting polymer. A thermoplastic polymer is one that turns to a liquid when heated and freezes to a glassy state when cooled sufficiently. Most thermoplastics are high-molecular-weight polymers whose chains associate through weak Van der Waals forces (e.g. polyethylene); stronger dipole-dipole interactions and hydrogen bonding (nylon); or even stacking of aromatic rings (polystyrene). A thermoplastic polymer is generally preferred because it is environmentally friendly, and can be reused. A thermosetting polymer is one that irreversibly cures after exposure to heat, chemical reaction, irradiation, or the like. Unlike thermosetting polymers, thermoplastic polymers may be reheated and remolded. Examples of thermosetting polymers include polyester resins, The physical properties of the polymer will vary depending upon the polymer chosen, but generally, polymers having a high tensile strength and resistance to temperatures ranging from approximately −200° F. to approximately 500° F. In a preferred embodiment, the polymer has resistance to temperatures ranging from approximately −150° F. to approximately 300° F.

Suitable examples of polymer include, but are not limited to acylonitrile butadiene styrene, acrylic, celluloid, celluloid acetate, cycloolefin copolymer, ethylene-vinyl acetate, ethylene vinyl alcohol, flouroplastics, ionomers, liquid crystal polymer, polyacetal, polyacrylates, polyacrylonitrile, polyamide, polyamide-imide, polyaryletherketone, polybutadiene, polybutylene, polybutylene terephthalate, polycyclohexylene dimethylene terephthalate, polycarbonate, polyhydroxyalkanoate, polyketone, polyester, polyethylene, polyetheretherketone, polyetherketoneketone, polyethimide, polyethersulfone, polyethylenechlorinate, polyimide, polylactic acid, polymethylpentene, polyphenylene oxide, polyphenylene sulfide, polyphthalamide, polypropylene, polystyrene, polysulfone, polytrimethylene terephthalate, polyurethane, polyvinyl acetate, polyvinyl chloride, polyvinylidene chloride, styrene-acrylonitrile, polyester fiberglass systems, Bakelite, vulcanized rubber, Duroplast, urea-formaldehyde, melamine resin, polyimides, and combinations thereof. In a preferred embodiment, the polymer is a thermoplastic polyethylene compound comprising ultra high molecular weight polyethylene (UHMWPE), ultra low molecular weight polyethylene (ULMWPE), high molecular weight polyethylene (HMWPE), high density polyethylene (HDPE), high density cross-linked polyethylene (HDXLPE), cross-linked polyethylenes (PEX or XLPE), medium density polyethylene (MDPE), low density polyethylene (LDPE), linear low density polyethylene (LLDPE), and very low density polyethylene (VLDPE). In a most preferred embodiment, the polymer comprises high density polyethylene, which has a melting point of about 266° F., a maximum structural temperature (the temperature to which the HDPE can be exposed, without altering the physical characteristics) of about 245° F. to about 250° F., a minimum structural temperature (the temperature to which the HDPE can be exposed without becoming brittle and cracking) of about −145° F. to about −150° F., and a tensile strength of at least approximatey 4500 psi.

In general, high density polyethylene is resistant to damage by ultraviolet radiation exposure. However, with the additional protection of the particulate matter, roofing shingles, for example, formed from composite building panels would have expected lifetimes of approximately 50 to 100 years without damage from direct sunlight, and further retain a desired appearance similar to stucco, particulate matterstone, terrazzo stone or the like. Further, the materials used are fully recyclable, and the initial layers of polymer and particulate matter may all be obtained from recycled materials.

The decorative side of the composite building panel is typically adorned with a particulate matter. The particulate matter is generally defined as a coarse material having a non-homogenous consistency similar to gravel or sand, which is capable of semi-uniform distribution across the decorative side of the composite building panel. One skilled in the art will appreciate that the components of particulate matter may vary, but typically consist of frit material (as typically incorporated into asphalt shingles), glass aggregate, or a combination thereof. The purpose of particulate matter is to provide a rough finish to the composite building panel, which is not only aesthetically pleasing to the consumer, but also provides for protection from mechanical stress and UV radiation. An important quality of the particulate matter is that it be heat resistant, meaning that it will not degrade upon exposure to temperatures up to at least 600° F. The frit material is typically defined as a ceramic composition that has been fused, quenched to form a glass, and granulated. Suitable examples of frit material include, but are not limited to organic or inorganic particulate matter including ground limestone, dolomite, silica, slate dust, silicon dioxide, granite, chert, sandstone, magnetite, ilmenite, monazite, garnet, tourmaline, anhydrite, chloritoid, malachite, sodium chloride, diamond powder, and the like. One of skill will appreciate that any combination of mineral granules, ceramic granules, or glass frit may be incorporated into the particulate matter of the composite building panel. Furthermore, the particle size of the frit material will vary depending upon the desired aesthetic effect. The particulate matter has a general particle diameter ranging from about 0.01 mm to about 50 mm. In a preferred embodiment, the particulate matter has a general particle diameter ranging from about 0.1 mm to about 10 mm. In a more preferred embodiment, the particulate matter has a general particle diameter ranging from about 0.5 mm to about 5 mm.

The particulate matter may also comprise glass aggregate. Glass aggregate is generally described as crushed glass that holds a grade, compacts well, and is capable of draining water. The sources of glass aggregate vary, but may include glass or ceramic bottles, glass jars, ceramic tableware and cookware, vases, ceramic flowerpots, plate glass, mirror glass, residential incandescent light bulbs, and the like. Unlike frit material, glass aggregate is typically made from recycled sources, and it does not biodegrade or corrode like frit material. Furthermore, the glass aggregate has a smoother surface (more like glass than sand or gravel) than frit material, and is available in a variety of colors. The size and diameter of glass aggregate particles will vary depending upon the desired appearance, but the diameter of glass aggregate particles generally ranges from about 0.01 mm to about 50 mm.

One embodiment of the composite building panel is shown in FIG. 1, which illustrates a plan view of the decorative side of the panel. In this embodiment, the decorative side is adorned with particulate matter that comprises both a frit material layer 12 and a glass aggregate layer 18. It should be understood that FIG. 1 is shown for illustrative purposes only. Preferably, frit material 12 and glass aggregate 18 are evenly distributed across (and partially embedded within) polymeric layer 14. When the particulate matter comprises more than one component, the components may be comingled to any degree sought by the manufacturer, such that the frit material and glass aggregate need not be evenly distributed across polymer layer 14 to achieve different decorative effects. It will be understood by one skilled in the art that a variety of components may be incorporated into the particulate matter, and that the degree of comingling between the different particulate matter components may be varied to impart different ornamental designs or pictures.

According to the embodiment illustrated in FIG. 1, the ratio of frit material 12 to glass aggregate 18 present on the decorative side of composite building panel 10 may range from approximately 99.99% frit material and 0.01% glass aggregate to about 0.01% frit material and 99.99% glass aggregate. In one embodiment, the ratio of frit material to glass aggregate present on the decorative side of composite building panel may range from approximately 25% frit material and 75% glass aggregate to about 25% frit material and 75% glass aggregate. In another embodiment, the ratio of frit material to glass aggregate present on the decorative side of composite building panel ranges from approximately 40% frit material and 60% glass aggregate to about 60% frit material and 40% glass aggregate. In addition, the surface coverage of the surface of the composite building panel comprising frit material and glass aggregate is generally at least 1% of the surface area. In a preferred embodiment, the surface coverage of the surface of the composite building panel comprising frit material and glass aggregate ranges from approximately 60% to approximately 99.9% of the surface area. In the more preferred embodiment of FIG. 1, the frit material 12 and glass aggregate 18 cover approximately 95% to approximately 99% of the surface area of the decorative side of composite building panel 10.

The thickness of the composite building panel can vary depending upon the desired qualities of the composite building panel. FIGS. 2A, 2B, and 2C illustrate the general design of the composite building panel contemplated in one embodiment of the current invention. FIGS. 2A, 2B, and 2C represent an embodiment of the current invention wherein the particulate matter comprises both frit material 12 and glass aggregate 18. However, it should be understood that the composite building panel comprises a composition where the particulate matter is comprised of a single component or multiple components, in any ratio desired. FIG. 2C illustrates that the layers of frit material 12 and glass aggregate 18 are oriented such that the layers are able to comingle. Although FIGS. 2B and 2C are drawn with distinct frit material and glass aggregate layers, the figure is illustrated for ease of illustration and understanding. In actuality, the frit material 12 and glass aggregate 18 are interspersed with one another, such that the two layers become a single layer. FIG. 2C also shows a layer of polymer 14 that is in contact with glass aggregate 18. As stated previously, FIG. 2C is drawn for ease of illustration and ease of understanding. In this embodiment, frit material 12 and glass aggregate 18 are interspersed, meaning that polymer 14 is in contact with both frit material 12 and glass aggregate 18. Polymer 14 is in contact with the frit material 12 and glass aggregate 18 by means of adhesion to the posterior portion of the frit material 12 and glass aggregate 18 granules. This type of contact results in a composite building panel where the frit material 12 and glass aggregate 18 are attached to the polymer 14 by the posterior portion of their respective granules, while maintaining an exposed anterior portion of the granules.

In addition, other components may be added to the decorative side and opposite side of the composite building panel to increase the functionality of the product. One additional component that may be added to the opposite side of the composite building panel to increase functionality is an attachment material. The attachment material is generally described as a material that is affixed to the opposite side, so as to create a rough texture on the posterior surface of the opposite side. The rough texture allows the user of the composite building panel to manipulate the panel more easily, and assists in the attachment of the panel to other material surfaces such as concrete, stucco, drywall, wood, or any other surface that the user may desire. Attachment material is generally considered to be an inter-woven material that is capable of integrating with the melted polymer of the composite building panel. The attachment material generally comprises a mesh material made of components such as fiberglass, polymers, aluminum, copper, brass, bronze, and the like. In a preferred embodiment, the attachment material comprises fiberglass mesh.

In one embodiment illustrated in FIG. 2D, an attachment material 13 is partially embedded within polymer 14, on the posterior surface of the opposite side of composite building panel 10 from the particulate matter 12 and glass aggregate 18. Although illustrated as being mounted to the composite building panel on the surface of the composite building panel with the frit material 12 and glass aggregate 18, it should be understood that the attachment material 13 is typically partially embedded on the opposite face of composite building panel from the particulate matter. In a preferred embodiment, attachment material 13 is partially embedded within polymer 14 such that certain portions of attachment material 13 are completely embedded within polymer 14 and certain other portions of attachment material 13 are exposed. The embedded portions of attachment material 13 provide adhesion to composite building panel 10, and the portions that are not embedded provide a rough surface that may be used for attachment to other materials.

Thus, one embodiment of the composite building panel, as illustrated in FIG. 2D, is a composite building panel 10 having one surface which is at least 60% covered with particulate matter comprising frit material 12 and glass aggregate 18, in a desired decorative pattern (with glass aggregate 18 having any desired color, texture, and density). In a preferred embodiment, composite building panel 10 has one surface which is approximately 85% to approximately 99.9% covered with particulate matter comprising frit material 12 and glass aggregate 18. In a more preferred embodiment, composite building panel 10 has one surface which is approximately 95% to approximately 99% covered with particulate matter comprising frit material 12 and glass aggregate 18. Furthermore, composite building panel 10 has an opposite surface comprising polymer 14, having an attachment material 13, preferably comprising fiberglass mesh or netting, partially embedded therein for bonding to an external surface.

Additional components that may be incorporated into the composite building panel include coloring agents, as well as fire retardants. One skilled in the art will recognize that the number and type of coloring agents that may be incorporated are very broad, but generally tend to include any pigments or dyes that the manufacturer desires. A fire retardant is generally defined as any chemical component that helps delay or prevent combustion or the spread of flames. Suitable examples of fire retardants include, but are not limited to aluminum hydroxide, magnesium hydroxide, hydromagnesite, antimony trioxide, red phosphorus, boron compounds, phosphonium salts, hydrochloric acid, organochlorines such as polychlorinated biphenyls, chlorenic acid derivatives, and chlorinated paraffins, organobromines such as polybrominated diphenyl ether, pentabromodiphenyl ether, octabromodiphenyl ether, decabromodiphenyl ether, and hexabromocyclododecane (HBCD); organophosphates in the form of halogenated phosphorus compounds such as tri-o-cresyl phosphate, tris(2,3-dibromopropyl) phosphate, bis(2,3-dibromopropyl) phosphate, tris(1-aziridinyl)-phosphine oxide, and the like.

One skilled in the art will appreciate that certain modifications may be made without departing from the scope of the invention. However, the invention generally does not comprise the use of asphalt or tar-based substrates as disclosed in the prior art. Similarly, although the composite building panel incorporates particulate matter, which may comprise frit material, glass aggregate, and combinations thereof, which are similar to the components of cement, the current invention generally does not comprise hydraulic or non-hydraulic cement or other cementitious aspects. Furthermore, the current invention does not incorporate the use of recycled rubber as a filler component or means for decreasing the cost of the product.

In another embodiment, the composite building panel further comprises a particle coating substance applied to the decorative side of the composite building panel. The particle coating substance is generally defined as being transparent, flexible, foldable, heat resistant, and capable of securing the particulate matter within the polymer. By securing the particulate matter, the particle coating substance prevents further loss of particles from the decorative side of the composite building panel when it is subjected to manipulation or other physical stresses. The particle coating substance thickness generally ranges from about 0.001 mm to about 5 mm thick. In a preferred embodiment, the particle coating substance thickness ranges from approximately 0.01 mm to approximately 2 mm thick. Although the coating is typically transparent, it can also be pigmented to give the composite building panel an alternative visual appeal. Further, the particle coating substance is typically applied to the particulate matter face of the composite building panel through spray application or similar techniques. The particle coating substance may include, but is not limited to binders, gums, glues, grout, paste, epoxies (including two-part epoxy coatings), plasters, sealants, glazes, lacquers, topcoats, varnish, enamels, laminates, paint, stains, urethane, and polyurea coatings. In a preferred embodiment, the particle coating substance is selected from the group comprising a clear enamel and a two-part epoxy.

Furthermore, the current invention also comprises a method for manufacturing composite building panels. The method comprises the steps of (a) depositing a layer of the particulate matter onto a molding surface, (b) depositing a layer of polymer comprising liquefied, melted, or solid pellets and granules onto the layer of particulate matter, and (c) adhering the particulate matter to the polymer such that the posterior surface of the particulate matter is partially embedded within the polymer. The physical state of the polymer when it is deposited onto the particulate matter, will determine the appropriate means for adhering the layers. If the polymer comprises a liquefied or melted polymer, the layers need to be cooled and allowed to solidify. If the polymer is deposited in solid pellets or granules, all layers will need to be exposed to a heating element at a temperature ranging from about 150° F. to about 600° F., which acts to melt the polymer and cause the polymer to adhere to the posterior surface of the particulate matter. The melting of the polymer results in partially embedded particulate matter, leaving a portion of the particulate matter exposed. Generally, the process described above results in the manufacture of a composite building panel as described herein. For the purposes of all embodiments, the particulate matter and polymer are as described previously. The heating process described above can generally be described as any means of heating the molding surface, particulate matter, and polymer, such that the polymer melts, adhering to the particulate matter on the posterior surface of the particulate matter.

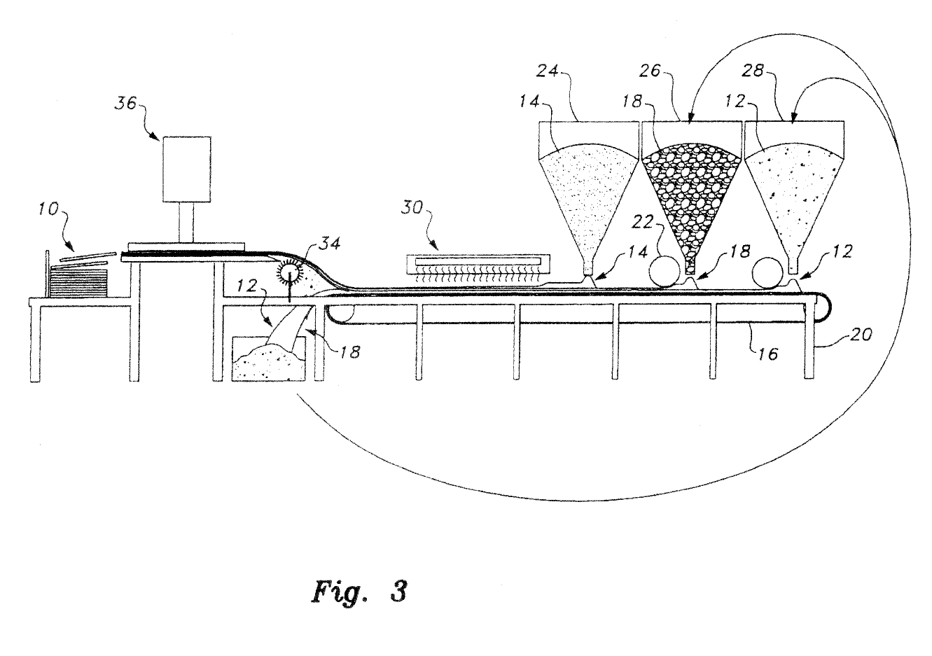

One embodiment of the method of manufacturing is illustrated in FIG. 3. In FIG. 3, the method described above comprises additional steps such that process involves the following steps: (a) depositing a layer of particulate matter on a molding surface, (b) depositing a layer of polymer on the layer of particulate matter, (c) heating the layers of polymer and particulate matter, melting the layer of polymer to form a sheet having the particulate matter partially embedded within the polymer, (d) cooling the layers of polymer and particulate matter, (e) contacting the particulate matter surface of the panel with a particle removal device to remove loose particles, (f) applying a particulate coating substance to the particulate matter surface to further attach the semi-loose particulate matter to those particles already adhered to the polymer during the melting process (not illustrated), and (g) feeding the particulate matter and polymer sheet to a panel cutting device, which cuts the continuous polymer and particulate matter sheet into separate composite building panel sections of a pre-determined size. The particulate matter and polymer are as defined previously. The heating process described in step (c) can generally be described as any means of heating the molding surface, particulate matter, and polymer, such that the polymer melts, adhering to the posterior surface of the particulate matter.

In the preferred embodiment of the method illustrated in FIG. 3, the particulate matter comprises a frit material 12 and a glass aggregate 18. In this embodiment, the process for preparing the composite building panel 10 includes the steps of first depositing a layer of the particulate matter 12 on to a molding surface 16, and then depositing a layer of the glass aggregate 18 to be mixed with the frit material layer 12. The initial layer of frit material 12 is deposited in a layer having a thickness ranging from approximately 1/100 of an inch to approximately 2 inches. In a preferred embodiment, the particulate matter layer has a thickness of between approximately 1/32 of an inch and ¾ of an inch. In a more preferred embodiment, the particulate matter layer has a thickness of between approximately ⅛ of an inch and ¼ of an inch. The general rule is that the thickness of the granule bed must be approximately four times the average diameter of the granules. If this minimum thickness is not established, the melted polymer will migrate through the particulate matter, and surround the granules that have flattened out onto the molding surface, failing to leave the particulate matter exposed on one surface of the composite building panel. This process leaves a loose layer of granules on the molding surface that is not adhered to the polymer substrate. The loose layer of granules represents the barrier layer keeping the molten or liquid polymer from reaching the molding surface. However, one skilled in the art will appreciate that the thickness of the particulate matter layer may be modified depending on the aesthetic result sought.

Further, the molding surface 16 is generally described as a heat-resistant surface that will not bind to the particulate matter 12, glass aggregate 18, or the polymer layer 14. In the embodiment of FIG. 3, the molding surface 16 comprises a conveyor belt, such that the process may be automated, free of human intervention.

Once the frit material 12 is deposited, the glass aggregate 18 is deposited onto frit material 12. Due to the similar size of frit material granules 12 and the glass aggregate granules 18, the glass aggregate 18 becomes comingled with frit material 12. One skilled in the art will also appreciate that the thickness of glass aggregate layer 18 may vary depending on the desired aesthetic effect. In a preferred embodiment, the glass aggregate layer 18 is deposited in a layer with a single-particle thickness, meaning that the thickness of the layer is approximately equal to the average diameter of a single piece of glass aggregate.

Next, polymer container 24 deposits polymer 14 on to frit material 12 and glass aggregate 18. Furthermore, the polymer layer 14 may be deposited in the form of a liquid or solid polymer. In the preferred embodiment of FIG. 3, the polymer 14 is supplied in the form of a solid granule or powder. The powdered polymer 14 preferably has a single particle diameter ranging from approximately 20 microns to approximately 500 microns. In a preferred embodiment the powdered polymer 14 preferably has a single particle diameter ranging from approximately 100 microns to approximately 300 microns. In a more preferred embodiment, the powdered polymer has a single particle diameter of approximately 200 microns. Additionally, in a preferred embodiment, the polymer layer 14 is deposited in a layer with thickness ranging from approximately 1/100 of an inch to approximately 2 inches. In a preferred embodiment, the deposited polymer layer 14 has a thickness ranging from approximately 1/32 of an inch to approximately ¾ of an inch. In a more preferred embodiment, the deposited polymer layer 14 has a thickness ranging from approximately ⅛ of an inch to approximately ¼ of an inch.

In FIG. 3, molding surface 16 comprises a conveyer belt which is mounted to a table 20, and frit material 12 and glass aggregate 18 are contained within containers 28 and 26, respectively. Powdered polymer 14 is shown being deposited from container 24, which is similar in construction to containers 26 and 28. It should be understood that the simplified diagram of FIG. 3 is shown for illustrative and exemplary purposes only, and that frit material 12, glass aggregate 18, and polymer 14 may be deposited on any suitable type of molding surface 16 via any suitable type of controllable deposition. In FIG. 3, frit material 12, glass aggregate 18, and polymer 14 are deposited in respective order by means of a controlled release hopper system comprising containers 28, 26, and 24, respectively.

In the embodiment illustrated in FIG. 3, the interspersion of frit material 12 and glass aggregate 18 is performed by a roller device 22. After frit material container 28 deposits frit material 12 onto molding surface 16, the deposited frit material 12 is passed under roller device 22, compressing and evenly distributing frit material 12 about molding surface 16. Subsequently, after glass aggregate container 26 deposits glass aggregate 18 onto molding surface 16, on top of frit material 12, the frit material 12 and glass aggregate 18 mix is passed under a second roller device 22, compressing and evenly distributing the frit material 12 and glass aggregate 18 about the molding surface 16.

In the next phase of the process as illustrated in FIG. 3, the frit material 12, glass aggregate 18, and polymer 14 are then subjected to heating element 30. As illustrated in FIG. 3, all three layers are subjected to heating element 30, melting polymer 14 to form a sheet of melted polymer 14, with frit material 12 and glass aggregate 18 partially embedded therein. It should be understood that any suitable type of heating device may be incorporated to melt the polymer layer 14, including the use of heating coils. Upon exposure to heating element 30, the frit material 12, glass aggregate 18, and polymer 14 are heated to a temperature sufficient to adequately melt the polymer 14. Polymer 14 is heated to a temperature ranging from approximately 150° F. to approximately 800° F. to melt the layer, thereby partially embedding the frit material 12 and glass aggregate 18 within polymer layer 14. In a preferred embodiment, the polymer 14 is heated to a temperature ranging from approximately 200° F. to approximately 650° F. In a more preferred embodiment, the polymer 14 is heated to a temperature ranging from approximately 220° F. to approximately 550° F.

The composite sheet formed from polymer 14 with frit material 12 and glass aggregate 18 partially embedded therein is then allowed to cool. The cooling process may take place by exposure to ambient air or by exposure to a cooling device apparatus (not illustrated in FIG. 3) designed to reduce the temperature of the composition. One skilled in the art will appreciate that a variety of methods may be used to cool the composite sheet. In one embodiment, the cooling device apparatus may comprise a water mister with one or more nozzles, capable of spraying water onto the sheet comprising polymer 14, glass aggregate 18, and particulate matter 12.

Additionally, as shown in FIG. 3, a particle removal device 34 may be provided for automatically removing loose frit material 12 and glass aggregate 18 as the panels are passed to panel cutting device 36. Particle removal device 34 is generally described as a device capable of contacting or creating a physical pressure with the frit material 12 and glass aggregate 18 sufficient to remove loose particulate matter and glass aggregate. In a preferred embodiment, the particle removal device comprises a rotary brush. In an additional embodiment, particle removal device 34 comprises an air circulation device that emits air at a pressure sufficient to remove loose particles. As shown by arrow 32, the collected frit material 12 and glass aggregate 18 may be recycled for usage in the production of new panels. Any suitable filtering and separation process may be utilized to separate frit material 12 from glass aggregate 18 and separately store the materials in their respective containers.

Individual panels are cut using panel cutting device 36 according to the desired size and shape of the finished product. One skilled in the art will appreciate that any device capable of cutting through a sheet of frit material 12, glass aggregate 18, and polymer 14 may be utilized. Each composite building panel 10 may then be stacked, as shown in FIG. 3, for packaging, storage and transport thereof.

In an additional embodiment, the method of manufacturing a composite building panel further comprises coating the particulate matter (which may comprise frit material, glass aggregate, or a combination thereof) surface of the sheet with a particle coating substance to secure the particulate matter particles and prevent further loss. This additional step comprises application of a thin film of particle coating substance to the particulate matter face of the particulate matter and polymer sheet after the sheet has been in contact with the particle removal device. The particle coating substance can be applied by any method known in the art. In a preferred embodiment, the particle coating substance is applied by spray application. The materials and thickness of the particulate coating substance are as described previously.

In an alternative embodiment, an extrusion process may be used to create the composite building panels of the current invention. Extrusion is generally defined as the process of feeding polymers in the form of small beads or pellets into an extrusion chamber, whereby a screw or similar device moves the polymer through the chamber, which is heated to a temperature sufficient to melt the polymer. Finally, the polymer is excreted through a die and applied in its molten state. According to this embodiment of the current invention, the process comprises the steps of: (a) depositing a layer of particulate matter on a molding surface; and (b) depositing a layer of molten polymer on to the layer of particulate matter, wherein the particulate matter layer and polymer layer are deposited in the order listed, leaving one surface of the composite building panel consisting of exposed particulate matter and the opposite surface of the composite building panel consisting of polymer.

According to this embodiment, the extrusion process would substitute molten polymer for the pellets or beads that were described in the previous embodiment. Thus, the molten polymer is deposited onto the particulate matter layer. It is important to note the layer of particulate matter is maintained, and the layer comprising the polymer is also preserved, such that the final product has a distinct layer of partially embedded particulate matter, and a distinct layer of polymer. With the exception of the molten polymer component, all other aspects of the method of this embodiment are similar or identical to previous embodiments. Thus, one skilled in the art will appreciate that molten polymer may be substituted for solid polymer in any of the methods of the current invention. The components of this process are similar to those disclosed with regard to the process of FIG. 3 (i.e. depositing layers of particulate matter, glass aggregate, and polymer, cooling the sheets, removing any loose particles, and cutting the sheet into individual panels) with the exception that this alternative method would eliminate the need to expose the particulate matter, glass aggregate, and polymer to a heating element, due to the fact that the polymer is melted prior to contact with the particulate matter and glass aggregate.

One skilled in the art will appreciate that many variations to the general manufacturing process are possible without departing from the spirit of the invention, including all methods by which the polymer is heated and melted prior to contacting the particulate matter. It is also important to recall that the physical characteristics of the composite building panel, with the exposed particulate matter and glass aggregate, most closely resemble the physical characteristics of an asphalt shingle, but with distinctly different components and physical characteristics. Although the composite building panel may be manipulated to provide for various aesthetic effects, it is not embossed or marked with any characteristics that generally resemble wood shake, slate or tile shingles.

Although the invention described herein is susceptible to various modifications and alternative iterations, specific embodiments thereof have been illustrated in the figures and have been described in greater detail above. It should be understood, however, that the detailed description of the figures is not intended to limit the invention to the specific embodiments disclosed. Rather, it should be understood that the invention is intended to cover all modifications, equivalents, and alternatives falling within the spirit and scope of the invention as defined by the claim language.

### EXAMPLE 1

### Synthesis of a Composite Building Panel

Reflective roofing frit (a mixture of particulate matter and glass aggregate) was evenly distributed onto a molding surface approximately ⅛ inch deep. The depth of the molding bed was established to a thickness sufficient to ensure that the polymer would not reach the bottom of the molding container upon liquefying. Next, a layer of high density polyethylene (polymer) powder with a 200 micron diameter was evenly distributed on top of the bed of granules. Subsequently, the high density polyethylene (HDPE) was heated to 266° F. until the material was melted throughout. The melted HDPE migrated into the bed of granules partially encapsulating and binding parts of the granules, leaving a portion of the surface of the reflective roofing frit exposed. Then, the mold was removed from the heat and allowed to cool. After the cooling process, the exposed side (with the exposed frit material) was subjected to a rotary brush, removing all loose material from the face of the panel, and a composite building panel was produced.

### EXAMPLE 2

### Synthesis of Composite Building Panel with Fiberglass Mesh Backing

The process for synthesizing the composite building panel was identical to that described in Example 1. Green glass aggregate was added to the frit granules to impart a different aesthetic appeal. However, prior to applying the HDPE layer to the granule bed, a layer of fiberglass mesh backing was added the layer of frit. Subsequently, the HDPE was deposited on top of the fiberglass mesh backing. The combination of frit, fiberglass mesh, and HDPE were then heated and cooled. After cooling, the HDPE encapsulated part of the frit, leaving one side of the frit completely exposed, with the fiberglass mesh backing partially encapsulated and partially exposed in the solidified HDPE layer. The partially exposed fiberglass mesh backing was sufficiently exposed to allow the attachment to a medium such as concrete. Thus, a composite building panel with an additional feature comprising a fiberglass mesh back was produced.

### EXAMPLE 3

### Synthesis of Composite Building Panel Incorporating a Corrugated Design

The process for synthesizing the composite building panel was again identical to the process described in Example 1. In this process, typical play sand was used as the frit material, along with pieces of black glass aggregate. After the sand and black glass aggregate were deposited onto the molding surface, cylindrical instruments were used to impart rounded impressions on the face of the sand and black glass aggregate. Subsequently, the HDPE was deposited onto the opposite side of the granules from the rounded impressions. The HDPE was then heated until it melted completely, and then allowed to cool. Upon cooling, the composite building panel maintained the rounded impressions on the face of the panel, illustrating the versatility of aesthetic effects possible with the invention.

### EXAMPLE 4

### Synthesis of a Composite Building Panel Laminated to a Piece of Like Material

The process for synthesizing the composite building panel was identical to the process described in Example 1. After the composite building panel was synthesized, it was desired that the panel be laminated to a piece of extruded plastic material, providing a backing with greater thickness and rigidity. The HDPE surface of the composite building panel, opposite the exposed frit side, along with the surface of the extruded plastic material were heated to a temperature sufficient to bind the two substances. Once an adequate temperature was achieved, the two components were pressed together and allowed to cool. The end product resulted in a rigid plastic backing with the composite building panel attached to one side of the plastic material, resulting in an aesthetically pleasing variation of the composite building panel. This process for creating a composite building panel with a rigid plastic backing is useful because frit can damage an injection mold quickly, so that process is not feasible for the creation of such a product. Lamination is the ideal method to create a composite building panel with these characteristics.

What is claimed is:

1. A composite building panel having opposed surfaces, comprising:
a polymer; and
a particulate matter partially embedded within a layer of the polymer,
wherein one surface of the composite building panel consists primarily of exposed particulate matter.

2. The composite building panel of claim 1, wherein the polymer comprises a polyethylene compound.

3. The composite building panel of claim 2, wherein the polyethylene compound is selected from the group consisting of ultra high molecular weight polyethylene, ultra low molecular weight polyethylene, high molecular weight polyethylene, high density polyethylene, high density cross-linked polyethylene, cross-linked polyethylenes, medium density polyethylene, low density polyethylene, linear low density polyethylene, very low density polyethylene, and a combination thereof.

4. The composite building panel of claim 3, wherein the polyethylene compound comprises high density polyethylene.

5. The composite building panel of claim 1, wherein the particulate matter is selected from the group consisting of granular ceramic frit, granular mineral frit, glass frit, glass aggregate, and a combination thereof.

6. The composite building panel of claim 1, wherein the one surface of the composite building panel consisting primarily of exposed particulate matter comprises a surface coverage of at least 60% of the exposed particulate surface of the composite building panel.

7. The composite building panel of claim 6, wherein the one particulate surface of the composite building panel consisting primarily of exposed particulate matter comprises a surface coverage of approximately 90% to approximately 99% of the exposed particulate surface of the composite building panel.

8. The composite building panel of claim 1, wherein the particulate matter partially embedded within a layer of the polymer comprises a thickness ranging from approximately 1/64 of an inch to approximately 1 inch.

9. The composite building panel of claim 8, wherein the particulate matter partially embedded within a layer of the polymer comprises a thickness ranging from approximately ⅛ of an inch to approximately ¼ of an inch.

10. The composite building panel of claim 1, wherein total thickness of the composite building panel ranges from approximately 1/32 of an inch to approximately 2 inches.

11. The composite building panel of claim 10, wherein the total thickness of the composite building panel ranges from approximately ⅛ of an inch to approximately ½ of an inch.

12. The composite building panel of claim 1, further comprising an attachment material affixed to the composite building panel opposite the one surface of the composite building panel consisting primarily of exposed particulate matter.

13. The composite building panel of claim 12, wherein the attachment material comprises a fiberglass mesh backing, a wire mesh backing, or a combination thereof.

14. The composite building panel of claim 1, further comprising a particulate coating substance uniformly applied across one surface of the composite building panel consisting primarily of exposed particulate matter.

15. The composite building panel of claim 14, wherein the particulate coating substance is selected from the group consisting of a clear enamel, a two-part epoxy, and combinations thereof.

16. A composite building panel having opposed surfaces, comprising:
a decorative surface consisting of a particulate matter and glass aggregate mixture, whereby the glass aggregate and particulate matter are partially exposed;
a polymeric surface opposite the decorative surface; and
an attachment material affixed to the polymeric surface.

17. The composite building panel of claim 16, wherein the polymer surface opposite the decorative surface comprises a polyethylene compound.

18. The composite building panel of claim 17, wherein the polyethylene compound is selected from the group consisting of ultra high molecular weight polyethylene, ultra low molecular weight polyethylene, high molecular weight polyethylene, high density polyethylene, high density cross-linked polyethylene, cross-linked polyethylenes, medium density polyethylene, low density polyethylene, linear low density polyethylene, very low density polyethylene, and combinations thereof.

19. The composite building panel of claim 18, wherein the polyethylene compound comprises high density polyethylene.

20. The composite building panel of claim 16, wherein the particulate matter comprises granular ceramic frit, granular mineral frit, glass frit, or a combination thereof.

21. The composite building panel of claim 16, wherein the decorative surface has a surface coverage of at least 60% of the composite building panel.

22. The composite building panel of claim 21, wherein the decorative surface has a surface coverage of approximately 90% to approximately 99% of the exposed particulate surface of the composite building panel.

23. The composite building panel of claim 16, wherein total thickness of the composite building panel ranges from approximately 1/32 of an inch to approximately 2 inches.

24. The composite building panel of claim 23, wherein the total thickness of the composite building panel ranges from approximately ⅛ of an inch to approximately ½ of an inch.

25. The composite building panel of claim 16, wherein the attachment material comprises a fiberglass mesh backing, a wire mesh backing, or a combination thereof.

26. The composite building panel of claim 16, further comprising a particulate coating substance uniformly applied across the decorative surface of the composite building panel.

27. The composite building panel of claim 26, wherein the particulate coating substance comprises a clear enamel, a two-part epoxy, or a combination thereof.

28. A composition for formulation of a composite building panel, comprising:
a layer of particulate matter;
a layer of glass aggregate; and,
a polymeric layer.

29. A composite building panel having opposed surfaces, comprising:
a decorative surface consisting of particulate matter selected from the group consisting of granular ceramic frit, granular mineral frit, glass frit, glass aggregate, and a combination thereof;
an opposite polymeric surface consisting of a polymer selected from the group consisting of ultra high molecular weight polyethylene, ultra low molecular weight polyethylene, high molecular weight polyethylene, high density polyethylene, high density cross-linked polyethylene, cross-linked polyethylenes, medium density polyethylene, low-density polyethylene, linear low-density polyethylene, and very low-density polyethylene, and a combination thereof;
an attachment material affixed to the polymeric surface wherein the attachment material is selected from the group consisting of fiberglass mesh backing, a wire mesh backing, and a combination thereof; and
a particulate coating substance selected from the group consisting of a clear enamel, a two-part epoxy, and a combination thereof;
wherein the total thickness of the composite building panel ranges from approximately ⅛ of an inch to approximately ½ of an inch and the particulate matter of the decorative surface covers at least 60% of the surface area of the decorative surface of the composite building panel.

30. A method of forming a composite building panel, comprising the steps of:
(a) depositing a layer of particulate matter onto a molding surface;
(b) depositing a layer of polymer onto the layer of particulate matter; and,
(c) heating the layers of polymer and particulate matter, melting the layer of polymer to form an intimate mixture between the particulate matter and the layer of polymer,
whereby the resulting composite building panel has an exposed particulate matter surface.

31. The method of claim 30, wherein the molding surface comprises a heat-resistant surface that will not bind to the particulate matter or polymer.

32. The method of claim 30, further comprising compressing the particulate matter with one or more roller devices.

33. The method of claim 30, wherein the layer of polymer comprises a polyethylene compound.

34. The method of claim 33, wherein the polyethylene compound comprises high density polyethylene with a particle diameter ranging from approximately 100 microns to approximately 300 microns.

35. The method of claim 30, wherein the layer of particulate matter is selected from the group consisting of granular ceramic frit, granular mineral frit, glass frit, glass aggregate, and a combination thereof.

36. The method of claim 30, wherein the layer of particulate matter is deposited at a thickness of about 1/64 of an inch to about 1 inch.

37. The method of claim 36, wherein the layer of particulate matter is deposited at a thickness of about ⅛ of an inch to about ¼ of an inch.

38. The method of claim 30, wherein the layers of polymer and particulate matter are heated to a temperature ranging from approximately 150° F. to approximately 600° F.

39. The method of claim 30, wherein the layer of polymer is deposited at a pre-heating thickness of approximately 1/64 of an inch to approximately 1 inch.

40. The method of claim 39, wherein the layer of polymer is deposited layer at a pre-heating thickness of approximately ⅛ of an inch to approximately ¼ of an inch.

41. The method of claim 30, further comprising integrating an attachment material opposite the layer of particulate matter, wherein the attachment material is partially embedded within the layer of polymer.

42. The method of claim 41, wherein the attachment material comprises a fiberglass mesh backing, wire mesh backing, or a combination thereof

43. The method of claim 30, further comprising depositing a layer of glass aggregate onto the layer of particulate matter, prior to depositing the layer of polymer.

44. The method of claim 30, comprising applying a particulate coating substance to the particulate matter surface.

45. The method of claim 44, wherein the particulate coating substance comprises a clear enamel or a two-part epoxy.

46. A method of forming a composite building panel, comprising the steps of:
(a) depositing a layer of particulate matter onto a molding surface; then
(b) depositing a layer of polymer onto the layer of particulate matter; then
(c) heating the layers of polymer and particulate matter, melting the layer of polymer to form an intimate mixture between the particulate matter and the polymer; then
(d) cooling the layers of polymer and particulate matter to form a sheet; then
(e) contacting the layer of particulate matter of the composite building sheet with a particle removal device to remove loose particles; then
(f) applying a particulate coating substance to the layer of particulate matter of the sheet; and then
(g) feeding the sheet to a panel cutting device, cutting the sheet into separate composite building panel sections of a pre-determined size,
whereby one surface of the composite building panel consists mostly of exposed particulate matter and the opposite surface of the composite building panel consists mostly of polymer.

47. A method of forming a composite building panel, comprising the steps of:
(a) depositing a layer of particulate matter onto a molding surface; and
(b) depositing a layer of molten polymer onto the layer of particulate matter to form the composite building panel having an exposed particulate matter surface.

48. The method of claim 47, wherein the layer of molten polymer comprises high density polyethylene.

49. The method of claim 47, wherein the layer of particulate matter comprises granular ceramic frit, granular mineral frit, glass frit, glass aggregate, or a combination thereof.

50. A method of forming a composite building panel, comprising the steps of:
(a) depositing a layer of particulate matter onto a molding surface; then
(b) depositing a molten layer of polymer onto the layer of particulate matter; then
(c) cooling the layers of polymer and particulate matter to form a particulate matter and polymer sheet having a particulate matter surface; then
(d) contacting the particulate matter surface with a particle removal device to remove loose particles; then
(e) applying a particulate coating substance to the particulate matter surface; and
(f) feeding the sheet to a panel cutting device, cutting the particulate matter and polymer sheet into separate composite building panel sections of a pre-determined size,
wherein the layers of particulate matter layer and polymer layer are deposited in the order listed, resulting in one surface of the composite building panel consisting mostly of exposed particulate matter and the opposite surface of the composite building panel consisting mostly of polymer.

51. The method of claim 50, further comprising integrating an attachment material opposite the layer of particulate matter, wherein the attachment material is partially embedded within the polymer layer.

52. The method of claim 51, wherein the attachment material comprises a fiberglass mesh backing, wire mesh backing, or a combination thereof.
